(19) United States
(12) Patent Application Publication
(10) Pub. No.: US 2010/0038408 A1
(43) Pub. Date: Feb. 18, 2010

(54) METHODS OF TREATING HARDBANDED JOINTS OF PIPE USING FRICTION STIR PROCESSING

(75) Inventors: Madapusi K. Keshavan, The Woodlands, TX (US); Russell J Steel, Salem, UT (US); Cary A. Roth, Spring, TX (US); Shelton W. Alsup, Houston, TX (US)

Correspondence Address: OSHA, LIANG LLP / SMITH, TWO HOUSTON CENTER, 909 FANNIN STREET, SUITE 3500, HOUSTON, TX, 77010, US

(73) Assignee: SMITH INTERNATIONAL, INC., Houston, TX (US)

(21) Appl. No.: 12/541,699

(22) Filed: Aug. 14, 2009

Related U.S. Application Data
(60) Provisional application No. 61/088,868, filed on Aug. 14, 2008.

(51) Int. Cl. B23K 20/12

(52) U.S. Cl. 228/112.1

(57) ABSTRACT

A method for treating a wear reducing material welded to a surface of a tool used in a wellbore operation that includes friction stirring the wear reducing material into the surface of the tool is disclosed. Method for improving the properties of a wear reducing material on a tool are also disclosed.

### CROSS-REFERENCE TO RELATED APPLICATIONS

This application claims priority, under 35 U.S.C. §119(e), to U.S. Patent Application No. 61/088,868, filed on Aug. 14, 2008, the contents of which are herein incorporated by reference in their entirety.

### BACKGROUND OF INVENTION

1. Field of the Invention

Embodiments disclosed herein relate generally to improved tool joints or other wear surfaces used in wellbore operations. In particular, embodiments disclosed herein relate generally to methods of applying wear resistant materials to and otherwise improving the properties of tool joints or other wear surfaces.

2. Background Art

Drilling wells for hydrocarbon recovery involves the use of drill pipes, to which at one end, a drill bit is connected for drilling through the formation. Rotational movement of the pipe ensures progression of the drilling. Typical pipes may come in sections of about 30 feet in length, and thus, these sections are connected to one another by a tool joint. Tool joints are the connecting members between sections of drill pipe—one member (the box) has an internal thread and the mating member (the pin) has an external thread, by which means they are assembled into a continuous unit with the drill pipe to form a drill string. Often, these tool joints have a diameter significantly larger than the body of the pipes, thus requiring protection against wear, particularly when drilling through highly abrasive, highly siliceous earth formations. In particular, as drilling proceeds, the tool joints rub against the drilled hole and/or drilled hole lining (i.e., casing). The strength of the connection is engineered around the wall thickness and heat-treated properties of the box above the thread. During drilling, the wall thickness above the thread thins as it rubs against the wall or casing. Thus, the life of the pipe is predicated upon the remaining strength of the tool joint.

Because increasing the life of the tool joint is desirable, there have been numerous attempts to provide weld a protective hardfacing alloy or cladding to the tool joint (or other wear prone surfaces such as a stabilizer or drill collar) to form a hardband. A variety of methods have been used to apply such wear-reducing materials to joints, including: GMAW (gas metal arc welding), GTAW (gas tungsten arc welding), PTA (plasma transferred arc), and FCAW (flux cored arc welding). These welding processes are characterized by establishing an arc between an electrode (either consumable or non-consumable) and a tool joint base material. Once this arc is established, intense heat forms a plasma. The gas that forms the plasma is furnished by means of an external gas or an ingredient from a tubular wire. The temperature of the plasma is in excess of 10,000 degrees Kelvin and is highest at the center of the weld, and decreases along the width of the weld.

Historically, and in practice, tool joints have been coated with tungsten carbide to resist the abrasion of the rock earth in the drill hole on the tool joint. However, tungsten carbide is expensive, it can act as a cutting tool to cut the well casing in which it runs, and the matrix is a soft steel which erodes away easily to allow the carbide particles to fall away.

Other prior art hardfacing materials used that are harder than siliceous earth materials are brittle and crack in a brittle manner after solidification and upon cooling due to the brittle nature of its structure and the inability of the structure to withstand solidification shrinkage stresses and typically emit sound energy upon cracking as well as causing considerable casing wear as previously stated. These hardfacing materials are alloys which belong to a well-known group of “high Cr-irons” and their high abrasive resistance is derived from the presence in the microstructure of the Cr-carbides of the eutectic and/or hypereutectic type.

Siliceous earth particles have a hardness of about 800 Brinell hardness number (BHN). In U.S. Pat. No. 5,244,559 the hardfacing material used is of the group of high Cr-irons that contains primary carbides which have a hardness of about 1700 Hv in a matrix of a hardness of at least 300 BHN to 600 Hv. These primary carbides at this high hardness are brittle, have little tensile strength and hence pull apart on cooling from molten state at a frequency that depends on the relative quantity of the primary carbides in the mix of metal and carbide. Thus, this type of hardfacing material, which is harder than silicious earth materials, when applied by welding or with bulk welding, form shrinkage cracks across the weld bead. This material has been applied extensively and successfully during many years for the hardbanding of tool joints and hardfacing of other industrial products.

Although these materials have become and still are widely accepted by the trade, users expressed a desire for a hardbanding tool joint alloy combining casing-friendliness with the capability of being welded free of brittle cracks in order to minimize any concerns of mechanical failure risks. Indeed, in most industries (including the oil and gas industry's use of down hole drilling equipment) the metal components which make up the structure and equipment of a given plant must have integrity, which means being free of any kind of cracks, because such cracks might be expected to progress through the piece and destroy the part.

U.S. Pat. No. 6,375,865 describes an alloy having a martensitic-austenitic microstructure which is preheated before welding to the industrial product and cooled down after welding. Alloys of this structural type can be deposited crack-free (further aided by the pre- and post-treatments and are characterized by excellent metal to metal wear properties and low brittleness.

Wear by abrasion mechanisms always has been, and still remains a main concern in many segments of industry, including the drilling industry. However, there is some limitation on the types of materials that may be used due to limitations of their use with GMAW, GTAW, PTA, and FCAW, as well as limitations on the types of materials which do not harm the casing.

Accordingly, there is a continuing need for developments in methods of improving the properties of a tool joint or other wear surfaces by applying treatment techniques and/or material in order to increase the component's service life.

### SUMMARY OF INVENTION

In one aspect, embodiments disclosed herein relate to a method for treating a wear reducing material welded to a surface of a tool used in a wellbore operation that includes friction stirring the wear reducing material into the surface of the tool.

In another aspect, embodiments disclosed herein relate to a method for improving the properties of a wear reducing material on a tool used in a wellbore operation that includes performing at least one heat treatment on at least a portion of the tool; welding to a surface of the tool a hardfacing alloy using metal gas arc welding; and friction stirring the wear reducing material into the surface of the tool.

In yet another aspect, embodiments disclosed herein relate to a method for improving the properties of a wear reducing material on a tool used in a wellbore operation that includes depositing a hardfacing alloy on a surface of a tool by thermal spray; and friction stirring the wear reducing material into the surface of the tool

Other aspects and advantages of the invention will be apparent from the following description and the appended claims.

### BRIEF DESCRIPTION OF DRAWINGS

FIG. 1 is a fragmentary longitudinal sectional view of a box of a tool joint with a raised hardband according to one embodiment.

FIG. 2 is a view similar to FIG. 1 illustrating a pin of the tool joint with a raised hardband according to one embodiment.

FIG. 3 is a view similar to FIG. 1 illustrating flush hardbanding of a box of the tool joint according to another embodiment.

FIG. 4 is a view similar to FIG. 1 illustrating flush hardbanding of a pin of the tool joint according to another embodiment.

FIG. 5 is a longitudinal view of a stabilizer hardbanded according to one embodiment.

FIGS. 6A to 6D illustrate use of a friction stir processing tool in accordance with one embodiment.

FIGS. 7A to 7B illustrate modification of a hardband weld in accordance with one embodiment.

FIG. 8 is a schematic of one embodiment of a hardband.

### DETAILED DESCRIPTION

In one aspect, embodiments disclosed herein relate to treatment of hardbands on the surface a tool used in a wellbore operation. In particular, embodiments disclosed herein relate to treatment of a hardband weld using friction stir processing.

The methods of the present disclosure may be used to treat a hardband or layer of wear reducing material on any type of tool used in a wellbore operations. However, particular embodiments may relate to use of friction stir processing to treat hardbanding previously applied using other welding techniques on a region of a downhole tool or component having a greater OD than other adjacent components, thus necessitating wear protection for the component. For example, components having a greater OD than other adjacent downhole components may include drill pipe joints, drill collars, stabilizers, etc. However, one skilled in the art would appreciate that the methods of the present disclosure are not so limited, and friction stir processing may instead be used to treat a wear reducing material located on any downhole component.

Friction stir processing uses a combination of rotational and orbital motion applied to the surface of an object to be treated. A rotating member is conventionally applied to the surface and is moved in an orbital fashion until a plasticized state of the material is achieved. The rotating member is moved along the surface to treat the material by changing the material microstructure.

Friction stir processing is similar to friction stir welding, with the exception that in welding two materials are being bonded together whereas the materials have previously been bonded together in the friction stir processing of the present disclosure. Friction stir processing generally involves engaging the material of two previously adjoined workpieces (i.e., previous weld) on either side of a joint by a rotating stir pin or spindle. Force is exerted to urge the spindle and the workpieces together, and frictional heating caused by the interaction between the spindle and the workpieces results in plasticization of the material on both sides of the joint. The spindle is traversed along the joint, plasticizing the material at the joint as it advances, and the plasticized material left in the wake of the advancing spindle cools and solidifies to form a treated weld.

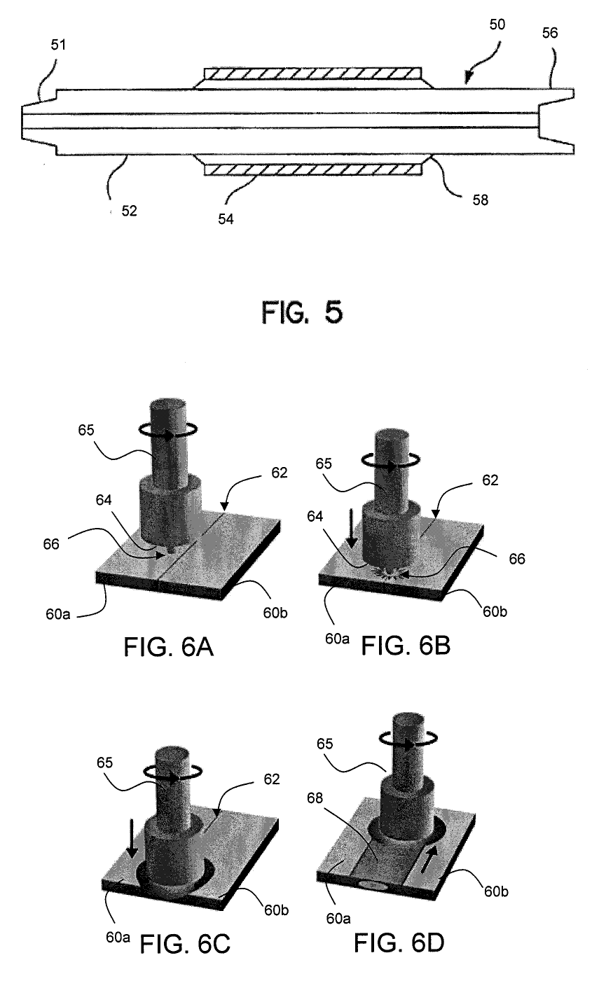

One example operation of a friction stir welding tool is shown in FIGS. 6A to 6D. As shown in FIG. 6A to 6D, two workpieces (e.g., workpieces, 60a, and 60b) have been previously bonded or welded together at interface or weld 62. A friction stir welding tool 65 has a shoulder 64 at its distal end, and a welding pin 66 extending downward centrally from the shoulder 64. As the rotating tool 65 is brought into contact with the weld 62 between workpieces 60a and 60b, the pin 66 is forced into contact with the material of both workpieces 60a and 60b, as shown. The rotation of the pin 66 in the material produces a large amount of frictional heating of both the welding tool pin 66 and shoulder 64 and at the weld 62. The heating tends to soften the material of the workpieces 60a and 60b in the vicinity of the rotating pin 66, thereby inducing a plasticization and commingling of material from the two workpieces 60a and 60b to form a treated weld 68.

However, as shown in FIG. 6A to 6D and described above in its conventional use, the friction stirring tool is moved along the interface in such a manner that the pin or spindle of the tool presses into the interface at an orientation that is co-planar with the interface/seam between the two objects. One skilled in the art would appreciate that when treating a wear resistant layer previously deposited on an outer surface of a tool, the pin or spindle of the friction stir welding tool is oriented perpendicular to the previously formed weld. Depending on the component being hardbanded and its configuration, one skilled in the art would appreciate that either orientation of the tool may be used.

The types of material that may be previously hardbanded, and thus may be treated using the friction stir welding methods disclosed herein, may depend on the desired material properties for the particular application, such as hardness, toughness, casing-friendly wear resistance, etc., as well as the type of wellbore in which the tool is being used (cased or open hole). However, in particular embodiments, the hardfacing alloy previously welded or bonded to a base tool material may include ferrous alloys, such as steel. Additional elements commonly found in ferrous alloys include, but are not limited to, chromium, molybdenum, manganese, silicon, carbon, boron, tungsten, titanium, niobium, tantalum, vanadium, nickel, cobalt, zirconium, and rhenium. Some of these alloys used in hardbanding may be described as “high melting temperature compounds,” or compounds having a melting temperature greater than steel. Other such high melting temperature compounds may form the base material of the tool components being used downhole. In open-hole drilling (where casing-friendliness is not as necessary), the alloy may be provided with tungsten carbide particles dispersed therein. However, lower melting temperature alloys may also be used.

During the friction stirring process, the previously applied (welding or otherwise applied) may have a hardness ranging from 45 to 55 Rockwell C. However, following the friction strirring process, the hardness of the wear reducing material may be increased by about 5 to 15 Rockwell C points, that is, to about 50 to 70 Rockwell C. Such change may result from the change in the material microstructure (i.e., through grain refinement/recrystallization to produce fine precipitates such as carbides). Another byproduct of the friction stirring techniques of the present disclosure may be a reduction in the surface roughness, i.e., reduced asperity heights.

The wear reducing materials may have previously been welded to or deposited on a tool surface using a variety of conventional methods such as GMAW (gas metal arc welding), GTAW (gas tungsten arc welding), PTA (plasma transferred arc), FCAW (flux cored arc welding), thermal spray, etc. Due to the phase transformations (to liquid state, then cooled to solid) that occur during such techniques, the microstructure can possess undesirable characteristics due to precipitation of unwanted phases or structures, grain growth, and create of residual stresses. Thus, one or more thermal treatments may have been performed on the welded material (including pre- and/or post-heat treatments) to relieve some of those residual stresses and minimize cracking. However, in accordance with embodiments of the present disclosure, the wear reducing material may then subsequently be friction stir processed to achieve an improved fine-grained microstructure (with improved material properties).

In order to treat or stir high melting materials (if used), referring back to FIG. 6A to 6D, the pin 66 and the shoulder 64 of the friction stir processing tool may be coated with a superabrasive material. In one embodiment, polycrystalline cubic boron nitride (PCBN) may be used as a superabrasive coating on a substrate material being used for the shoulder 64 with the integral pin 66. In a preferred embodiment, rather than a coating, the shoulder 64 and the pin 66 (which may or may not be integrally formed with the shoulder) are formed of polycrystalline cubic boron nitride themselves, rather than being coated. Tools suitable for use in the methods of the present disclosure may include tools similar to those discussed in U.S. Pat. Nos. 7,124,929, 7,270,257, and U.S. Patent Publication No. 2005/0082342, which are assigned to the present assignee and herein incorporated by reference in their entirety.

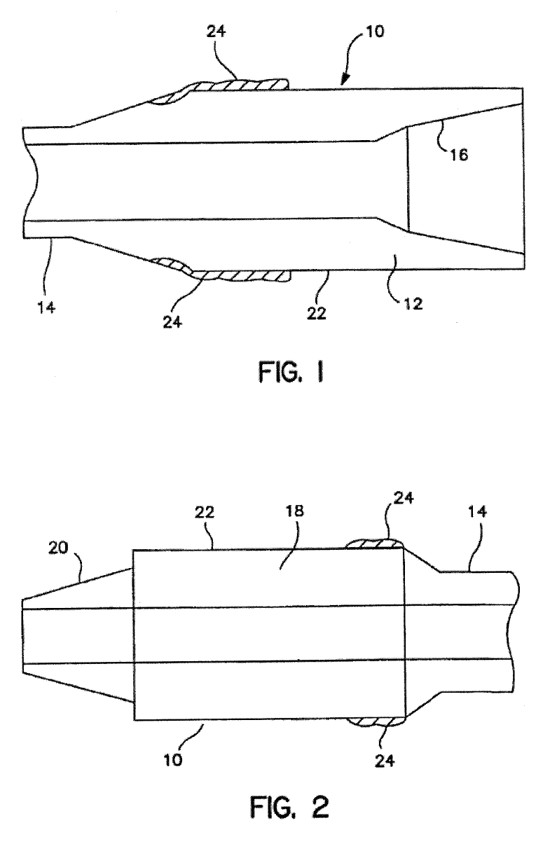

Referring now to FIGS. 1 and 2, one example of a downhole tool, in particular, a drill pipe joint that has been provided with hardband that is treated with friction stir processing is shown. As shown in FIGS. 1 and 2, a tool joint 10 for drill pipe 14 is illustrated which has a box 12 at the end of the drill pipe 14 that is internally threaded at 16. Internal threads 16 of box 12 threadedly receive a pin 18 having co-acting threads 20 to the threads 16 so that the pin 18 may be threaded into box 12. The pin 18 forms the end of a drill pipe, such as 14, so that a string or joints of pipe may be threadedly secured together and disconnected for drilling oil, gas, and other wells.

The box 12 and the pin 18 are enlarged and have outer cylindrical surfaces 22 having an outer diameter greater than the outer diameter of the drill pipe 14 onto which hardbanding 24 is deposited. In such an embodiment, the outer diameter of the coupling at the hardband 24 is greater than the outer cylindrical surfaces 22 such that the hardband preferentially contacts the borehall wall or casing when the tool joint is employed in a drill string. One skilled in the art would appreciate that when selecting the outer diameter of the hardband 24, care should be taken, with consideration as to the borehole diameter in which the drill string is being used to reduce adverse effects on annular flow of drilling fluids through the borehole to the surface. For example, such thickness of the hardbanding may range from about about 3/32 to ¼ inch thick without detriment to the alloy properties and may be deposited in single or double layers. Thus, the friction stir processing methods may be used to treat/stir a previously formed weld.

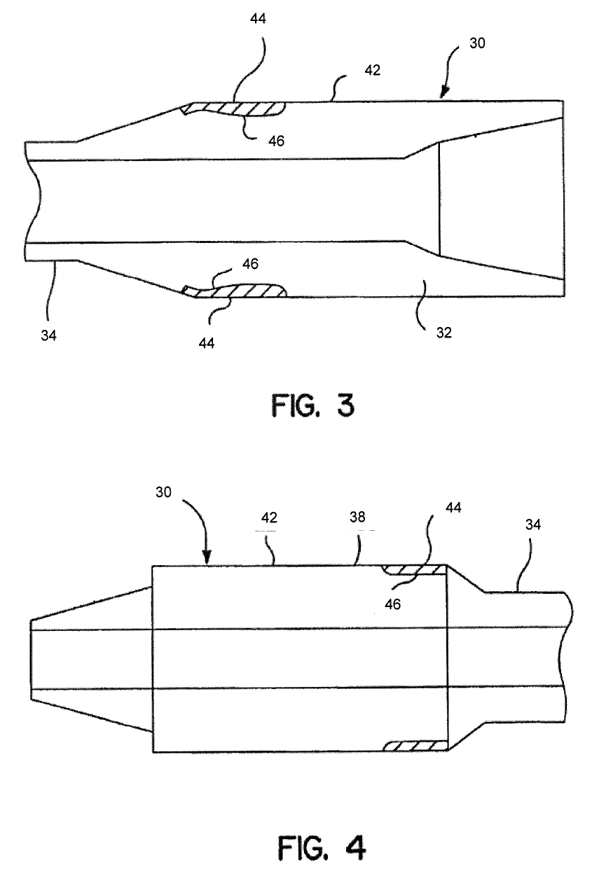

Referring now to FIGS. 3 and 4, another embodiment of a tool joint 30 for drill pipe 34 is shown. Tool joint 30 is similar to tool join 10 of FIGS. 1 and 2 except that tool joint 30 has a reduced cylindrical portion 46 formed by either the removal of a circumferential band of material from the outer cylindrical surfaces 42 of the box 32 and the pin 38 or was originally formed with these reduced diameter sections 32, and the hardbanding 44 is welded (or otherwise deposited) in this space so that the surface of the weld deposited hardfacing is substantially flush with the outer cylindrical surface 42 of the box 32 and the pin 38. One skilled in the art would appreciate that when a flush hardbanding is desired, an amount of material similar to the thickness of the hardband 24 shown in FIGS. 1 and 2 may be removed from the tool joint 30 so that a similar thickness of hardband 44 may be deposited thereon and be flush with the outer surfaces 42.

Referring to FIG. 5, a stabilizer 50 according to the present disclosure is illustrated. Stabilizier 50 has an elongated cylindrical or pipe-like body 52 having a pin 51 and box 56 for connection in a string of drill pipe (not shown). The stabilizer 50 possesses stabilizer ribs 58 extending outwardly from body 52 for stabilizing the drill pipe in a well bore (not shown). Hardbanding alloy 54 is welded to or otherwise deposited on stabilizer ribs 58. Further, while the methods of the present disclosure is particularly suited for treating hardbanded tool joints and stabilizers, it may be applied to any surface having been hardbanded or hardfaced, such as drill collars, structural members, process components, abrasion resistant plates, and the like.

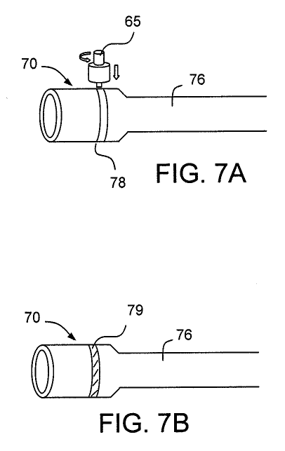

Thus, while the present application is directed to the general use of friction stir processing to modify or treat a previously welded or deposited hardfacing alloy on the outer surface of a downhole tool, one skilled in the art would appreciate that the hardband may take a variety of shapes and forms, and may be formed on any surface of a tool. For example, in one embodiment, the hardband for treatment in accordance with the present disclosure may be raised from the outer surface of a tubular member. Referring to FIGS. 7A to 7B, a friction stir welding tool 65 (having shoulder and pin components as described above) may be brought into contact with a hardbanding 78 located on joint 70 of drill pipe 76. As the tool 65 rotates and is forced normal to the surface of the hardbanding 78, frictional heating generated from the rotation of the tool 65 softens the material of the hardbanding and surrounding or adjacent joint 70 material in the vicinity of the rotating tool 65, thereby inducing a plasticization and commingling of material from the previously placed hardband 78 and joint 70 to form a re-weld 79.

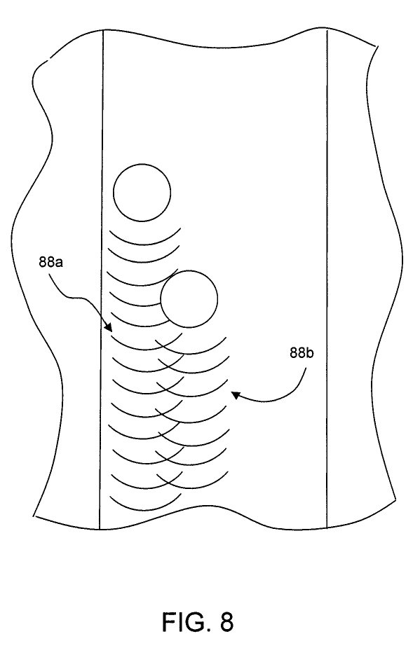

Moreover, it is also within the scope of the present disclosure that during the friction stirring treatment process, treating the entire hardband region may be accomplished in one or more passes, depending, for example, on the width of the material to be treated on the tool. Thus, for example, for a hardband wider than an available friction stir processing tool, multiple passes of stirring 88a, 88b may be performed, such as shown in FIG. 8. During such multiple passes, some embodiments may change the direction of rotation of the tool while other embodiments may use the same rotation direction between the multiple passes. Further, one skilled in the art would appreciate that during the stirring process, some of the base material adjacent the previously placed hardband may also be stirred despite not having an additional material mixed therewith.

Further, in such a manner, hardbandings (either formed from conventional processes or modified hardbands) are generally repairable. Thus, in particular, the downhole components may be repeatedly recoated with a hardbanding layer, or simply retreated, either in a shop or in the field at the rig location. Further, when performing a re-coat, the friction stir processing of a new metal alloy into the used pipe may be performed on the same or different earlier weld type.

Advantageously, embodiments of the present disclosure may provide for at least one of the following aspects. Conventional welding processes present limitations on the types of hardbanding materials which can be used in hardbanding a downhole toole. For example, using welding techniques conventionally used in hardbanding, e.g., gas metal arc welding, the hardbanding material options are limited. Specifically, materials that are casing friendly are difficult to weld, and result in cracking (despite pre- and post-heat treatments) due to the stresses which arise in the microstructure during the liquid-to-solid transition during welding. Moreover, materials which are more easily weldable using conventional means (such as conventional tungsten carbide containing hardbands) are known to wear down a casing string.

However, using the friction stir treatment methods of the present disclosure, the solid-state processing principles associated with friction stir welding/processing may likely reduce the microstructure defects present in the original weld or deposit, reducing the incidence of cracking. By reducing the incidence of cracking, the need for additional heat processing treatments, such as pre- and/or post-heat treatments may be eliminated. Additionally, the processing technique may be less hazardous, which may also allow for the hardbanding to be treated at any given location, including at the rig site, allowing for better rebuild service. Lower asperity heights may also be achievable, giving a smoother finish, and reducing an apparent need for surface finishing or grinding.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method for treating a wear reducing material welded to a surface of a tool used in a wellbore operation, comprising:
friction stirring the wear reducing material into the surface of the tool.

2. The method of claim 1, wherein friction stirring comprises exerting a downward force onto and rotating a friction stir processing pin to generate frictional heat such that the pin enters the alloy and tool surface and creates a plasticized region in the alloy and the tool.

3. The method of claim 1, wherein the hardfacing alloy comprises a ferrous based alloy.

4. The method of claim 1, wherein the hardfacing alloy comprises tungsten carbide particles dispersed therein.

5. The method of claim 1, wherein after the friction stirring, the weld has a reduced average asperity height.

6. The method of claim 1, wherein the tool comprises at least one of a tool joint, a drill collar, and a stabilizer.

7. The method of claim 1, wherein prior to friction stirring, the wear reducing material has a hardness ranging from 45 to 55 Rockwell C.

8. The method of claim 1, wherein after friction stirring, the wear reducing material has hardness ranging from 50 to 70 Rockwell C.

9. The method of claim 7, wherein friction stirring increases the hardness of the wear reducing material by about 5 to 15 Rockwell C.

10. A method for improving the properties of a wear reducing material on a tool used in a wellbore operation, comprising:
performing at least one heat treatment on at least a portion of the tool;
welding to a surface of the tool a hardfacing alloy using metal gas arc welding; and
friction stirring the wear reducing material into the surface of the tool.

11. The method of claim 10, further comprising:
performing at least a second heat treatment on at least a portion of the tool.

12. The method of claim 10, wherein the at least one heat treatment occurs prior to the welding.

13. The method of claim 11, wherein the at least a second heat treatment occurs after the welding, prior to the friction stirring.

14. The method of claim 10, wherein the friction stirring comprises at least one stirring pass.

15. The method of claim 14, wherein the friction stirring comprises at least two stirring passes.

16. The method of claim 10, wherein friction stirring comprises exerting a downward force onto and rotating a friction stir processing pin to generate frictional heat such that the pin enters the alloy and tool surface and creates a plasticized region in the alloy and the tool.

17. The method of claim 10, wherein the hardfacing alloy comprises a ferrous based alloy.

18. The method of claim 10, wherein the hardfacing alloy comprises tungsten carbide particles dispersed therein.

19. The method of claim 10, wherein after the friction stirring, the weld has a reduced average asperity height.

20. The method of claim 10, wherein the tool comprises at least one of a tool joint, a drill collar, and a stabilizer.

21. A method for improving the properties of a wear reducing material on a tool used in a wellbore operation, comprising:
depositing a hardfacing alloy on a surface of a tool by thermal spray; and
friction stirring the wear reducing material into the surface of the tool.

22. The method of claim 21, wherein the friction stirring comprises at least one stirring pass.

23. The method of claim 22, wherein the friction stirring comprises at least two stirring passes.

24. The method of claim 21, wherein friction stirring comprises exerting a downward force onto and rotating a friction stir processing pin to generate frictional heat such that the pin enters the alloy and tool surface and creates a plasticized region in the alloy and the tool.

25. The method of claim 21, wherein the hardfacing alloy comprises a ferrous based alloy.

26. The method of claim 21, wherein the hardfacing alloy comprises tungsten carbide particles dispersed therein.

27. The method of claim 21, wherein after the friction stirring, the weld has a reduced average asperity height.

28. The method of claim 21, wherein the tool comprises at least one of a tool joint, a drill collar, and a stabilizer.
